(19) United States
(12) Patent Application Publication
(10) Pub. No.: US 2009/0136626 A1
(43) Pub. Date: May 28, 2009

(54) FILTER PAPER INSERT

(75) Inventor: Georg MUELLER, Minden (DE)

Correspondence Address: VENABLE LLP, P.O. BOX 34385, WASHINGTON, DC, 20043-9998, US

(73) Assignee: Melitta Haushaltsprodukte GmbH & Co. KG, Minden (DE)

(21) Appl. No.: 12/269,145

(22) Filed: Nov. 12, 2008

(30) Foreign Application Priority Data
Nov. 12, 2007 (DE) 20 2007 015 863.7

(51) Int. Cl. A23F 5/46; B65D 85/804

(52) U.S. Cl. 426/78

(57) ABSTRACT

A filter paper insert includes a filter paper shaped to define at least one side wall surrounding an inside space and an aromatic substance printed on an area of the filter paper.

### CROSS-REFERENCE TO RELATED APPLICATION

This application claims the priority of the German patent document DE 20 2007 015 863.7, filed on Nov. 12, 2007, the subject matter of which is incorporated herein by reference.

### BACKGROUND OF THE INVENTION

The present invention relates to a filter paper insert, used in particular for coffee, comprising an inside space that can be filled and is surrounded by side walls.

Filter paper inserts already exist, which are provided with stamped markings indicating an amount of coffee grounds to be filled in, for which a specific amount of water must flow through the coffee maker. Stamped areas of this type are non-problematic with respect to food safety laws, but are also hard to see for the consumer.

### SUMMARY

It is therefore an object of the present invention to provide a filter paper insert which can be used quite safely with respect to the food safety laws, but which also allows a differentiation in taste.

The above and other objects are accomplished according to one aspect of the invention wherein there is provided a paper filter insert comprising a filter paper shaped to define at least one side wall surrounding an inside space and an aromatic substance printed on an area of the filter paper.

### BRIEF DESCRIPTION OF THE DRAWINGS

The present invention will be more readily understood from the following detailed description when read in conjunction with the accompanying drawings, in which:

FIG. 1 is a view of a filter paper insert according to the invention.

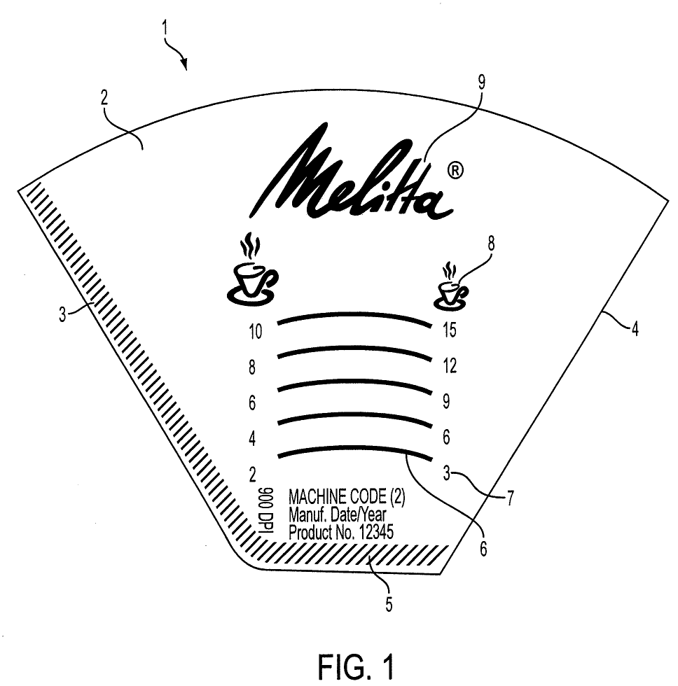

### DETAILED DESCRIPTION

A filter paper insert 1, in particular used for coffee grounds, comprises two opposite-arranged side walls, which are connected on one side by an embossed seam 3 and on the opposite side by a folding edge 4. On the bottom, the filter paper insert 1 is closed off by an embossed seam 5.

To improve the handling, the filter paper insert 1 is provided on the outside of at least one side wall 2 with printed area 6, 7, 8 and 9 that contains an aromatic substance. The printed area can be realized with diverse printing methods such as ink-jet printing, flexographic printing, tampon printing or offset printing.

The substances used can be natural aromatic substances such as chocolate or cocoa, juice concentrates, or other aromatic substances. As a result, a noticeable color contrast is created to the white or brown areas of the filter paper insert that are not imprinted. When the filter paper insert 1 is in use, at least a portion of the aromatic printing can dissolve and provide the brewed beverage with a personal touch.

For the embodiment shown herein, the printed area involves metering lines 6, as well as numbers 7, which indicate the amount of coffee grounds to be filled in relative to the amount of brewing water. Also printed on are the symbols 8 for the size of the cup, as well as a manufacturer's logo 9. Other functional elements and markings can also be printed onto the side wall 2, for example information on the manufacturer, product notices, and other elements.

It will be understood that the above description of the present invention is susceptible to various modifications, changes and adaptations, and that the same are intended to be comprehended within the meaning and range of equivalents of the appended claims.

What is claimed is:

1. A filter paper insert, comprising;
a filter paper shaped to define at least one side wall surrounding an inside space; and
an aromatic substance printed on an area of the filter paper.

2. The filter paper insert of claim 1, wherein the filter paper has a color and the aromatic substance has a color that contrasts with the color of the filter paper.

3. The filter paper insert of claim 1, wherein the aromatic substance consists of natural aromatic substances.

4. The filter paper insert of claim 1, wherein the aromatic substance comprises chocolate or cocoa.

5. The filter paper insert of claim 1, wherein the aromatic substance printed on an area of the filter paper is visible on both sides of the filter paper.

6. The filter paper insert of claim 1, wherein the aromatic substance printed on the filter paper includes visible metering lines that are arranged on the side wall.

7. The filter paper insert of claim 1, wherein the aromatic substance printed on the filter paper extends over at least one side wall.
